(19) United States
(12) Patent Application Publication
(10) Pub. No.: US 2026/0102735 A1
(43) Pub. Date: Apr. 16, 2026

(54) SEPARATION MEMBRANE COMPLEX AND METHOD OF PRODUCING SEPARATION MEMBRANE COMPLEX

(71) Applicant: NGK INSULATORS, LTD., Nagoya-City (JP)

(72) Inventors: Makoto MIYAHARA, Tajimi-Shi (JP); Kenichi NODA, Nagoya-Shi (JP); Tomoyo AKAHIRA, Nagoya-Shi (JP); Daiki KAZAOKA, Tokai-Shi (JP)

(73) Assignee: NGK INSULATORS, LTD., Nagoya-City (JP)

(21) Appl. No.: 19/419,491

(22) Filed: Dec. 15, 2025

Related U.S. Application Data
(63) Continuation of application No. PCT/JP2024/016040, filed on Apr. 24, 2024.

(30) Foreign Application Priority Data
Aug. 16, 2023 (JP) 2023-132688

(51) Int. Cl. B01D 53/22; B01D 67/00; B01D 69/02; B01D 71/06

(52) U.S. Cl. CPC B01D 53/228; B01D 67/0079; B01D 67/0095; B01D 67/0097; B01D 69/02; B01D 71/06; B01D 2256/22; B01D 2257/102; B01D 2325/02831; B01D 2325/04

(57) ABSTRACT

A separation membrane complex includes a support that is porous, and a separation membrane with an amine supported on a surface thereof and in pores thereof in the vicinity of the surface, and the separation membrane complex is a membrane of a metal organic framework provided on the support and has a mean pore diameter of greater than or equal to 0.40 nm and less than or equal to 0.90 nm. In producing the separation membrane, an amine-containing solution is brought into contact with a surface of the membrane of the metal organic framework so that the amine is supported on the membrane.

### CROSS-REFERENCE TO RELATED APPLICATIONS

The present application is a continuation application of International Application No. PCT/JP2024/016040 filed on Apr. 24, 2024, which claims priority to Japanese Patent Application No. JP2023-132688 filed in the Japan Patent Office on Aug. 16, 2023. The contents of these applications are incorporated herein by reference in their entirety.

### TECHNICAL FIELD

The present invention relates to a separation membrane complex and a method of producing a separation membrane complex.

### BACKGROUND ART

With the global effort for carbon neutrality in recent years, there are increasing needs for technologies for separating and collecting carbon dioxide (CO₂) contained in industrial emissions from plants or the like. As one carbon dioxide separation technology, utilization of a mesoporous silica membrane is conventionally proposed. For example, according to Japanese Patent Application Laid-Open No. 2007-44677 (Document 1), a precursor solution is applied on a porous support impregnated with liquid paraffin to form a gel membrane. Then, the liquid paraffin and a surfactant contained in the gel membrane are removed by firing to obtain a mesoporous silica membrane. Thereafter, reflux processing using a silane coupling agent having basic functional groups are performed in order to introduce the basic functional groups into the mesoporous silica membrane.

According to International Publication No. 2022/209002 (Document 2), a zeolite interlayer with pores having a small mean pore diameter is provided on a porous support, and a mesoporous silica membrane serving as a separation membrane is provided on the interlayer. Then, functional groups such as an amino group are introduced into pores in the surface layer of the separation membrane.

Meanwhile, a metal-organic framework (hereinafter also referred to as an “MOF”) is a porous material having a large surface area and is expected to be applied to the separation of gases or liquids by being formed as a membrane on a porous support as in the case of a zeolite membrane or a mesoporous silica membrane. “Amine-modified Mg-MOF-74/CPO-27-Mg membrane with enhanced H₂/CO₂ separation”, by NanyiWang and other four members, Chemical Engineering Science, 124 (2015) 27-36 (Document 3) proposes a technique that uses an MOF for the separation of a specific gas. According to Document 3, a separation membrane with ethylenediamine supported on an MOF membrane is obtained by forming an Mg-MOF-74 membrane as the MOF membrane on a support and subjecting the MOS membrane to reflux processing conducted at 110° C. in a solution obtained by dissolving ethylenediamine in toluene.

According to Document 1, the reflux processing causes a chemical reaction between the mesoporous silica membrane and the silane coupling agent having the basic functional groups. According to Document 3, the reflux processing causes the introduction of ethylenediamine into the MOF membrane. Thus, a large amount of amine becomes embedded in the entire separation membrane in Documents 1 and 3, causing deterioration in permeability to a target gas.

Besides, according to Document 1, the reflux processing needs to be performed by heating the toluene dissolved in the aminopropyltriethoxysilane to 150° C. in an argon gas atmosphere.

This makes it difficult to process a large membrane. The separation membrane according to Document 2 is excellent in CO₂ separation performance because of the presence of the interlayer, but its complicated structure makes it difficult to lower the cost of production. Moreover, the mesoporous silica membrane has a mean pore diameter of greater than or equal to 1 nm, and the amine is chemically bonded to the mesoporous silica membrane. The separation membrane according to Document 3 is unsuitable for the separation of CO₂ and N₂ because the MOF has a mean pore diameter of greater than or equal to 1 nm and has nitrogen (N₂) permeability higher than CO₂ permeability. This separation membrane is also thought to have high resistance to permeability because of the presence of the amine inside the support.

### SUMMARY OF THE INVENTION

It is an object of the present invention to provide a separation membrane complex that exhibits high performance on the separation of a specific gas while suppressing deterioration in fluid permeability, and to provide a method of producing the separation membrane complex.

Aspect 1 of the present invention is a separation membrane complex that includes a support that is porous, and a separation membrane with an amine supported on a surface thereof and in pores thereof in the vicinity of the surface, the separation membrane being a membrane of a metal organic framework provided on the support and having a mean pore diameter of greater than or equal to 0.40 nm and less than or equal to 0.90 nm.

According to Aspect 1 of the present invention, it is possible to provide a separation membrane complex that exhibits high performance on the separation of a specific gas while suppressing deterioration in fluid permeability.

Aspect 2 of the present invention is the separation membrane complex according to Aspect 1, in which metal ions serving as a component of the metal organic framework is at least one selected from a group consisting of Al³⁺, Co³⁺, Co²⁺, Ni²⁺, Ni⁺, Cu²⁺, Cu⁺, Zn²⁺, Fe³⁺, Fe²⁺, Ti³⁺, and Zr⁴⁺.

Aspect 3 of the present invention is the separation membrane complex according to Aspect 1 (or according to Aspect 1 or 2), in which an organic ligand serving as a component of the metal organic framework is a bidentate ligand that is an organic molecular ion having two carboxy groups.

Aspect 4 of the present invention is the separation membrane complex according to Aspect 1 (or according to any one of Aspects 1 to 3), in which the amine includes one or more types of normal amines.

Aspect 5 of the present invention is the separation membrane complex according to Aspect 1 (or according to any one of Aspects 1 to 4), in which the mean pore diameter is greater than or equal to 0.40 nm and less than or equal to 0.70 nm.

Aspect 6 of the present invention is the separation membrane complex according to Aspect 1 (or according to any one of Aspects 1 to 5), in which a ratio of permeance of CO₂ to permeance of a target gas is higher than or equal to five, the target gas being a gas separated from the CO₂.

Aspect 7 of the present invention is the separation membrane complex according to Aspect 1 (or according to any one of Aspects 1 to 6), in which the separation membrane has an average membrane thickness of greater than or equal to 0.5 μm and less than or equal to 2 μm.

Aspect 8 of the present invention is the separation membrane complex according to any one of Aspects 1 to 7, in which an abundance of the amine per unit volume gradually decreases from the surface of the separation membrane toward the support.

Aspect 9 of the present invention is a method of producing a separation membrane complex, the method including a) depositing a seed crystal of a metal organic framework on a support that is porous, b) preparing a starting material solution of a metal organic framework, c) immersing the support in the starting material solution to form a membrane of the metal organic framework on the support by Solvothermal synthesis, the membrane of the metal organic framework having a mean pore diameter of greater than or equal to 0.40 nm and less than or equal to 0.90 nm, and d) bringing an amine-containing solution into contact with a surface of the membrane of the metal organic framework.

According to Aspect 9 of the present invention, it is possible to provide a method of producing a separation membrane complex that exhibits high performance on the separation of a specific gas while suppressing deterioration in fluid permeability.

Aspect 10 of the present invention is the method of producing a separation membrane complex according to Aspect 9, the method further including, between the operations c) and d), e) drying the membrane of the metal organic framework, and f) keeping the membrane of the metal organic framework in a high-humidity environment.

These and other objects, features, aspects and advantages of the present invention will become more apparent from the following detailed description of the present invention when taken in conjunction with the accompanying drawings.

### BRIEF DESCRIPTION OF DRAWINGS

FIG. 1 is a sectional view of a separation membrane complex.

FIG. 2 is an enlarged sectional view showing part of the separation membrane complex.

FIG. 3 is a flowchart showing the production of the separation membrane complex.

FIG. 4 is a diagram illustrating amine-support treatment.

FIG. 5 is a diagram showing a separation apparatus.

FIG. 6 is a flowchart showing the separation of a mixture of substances by the separation apparatus.

### DETAILED DESCRIPTION

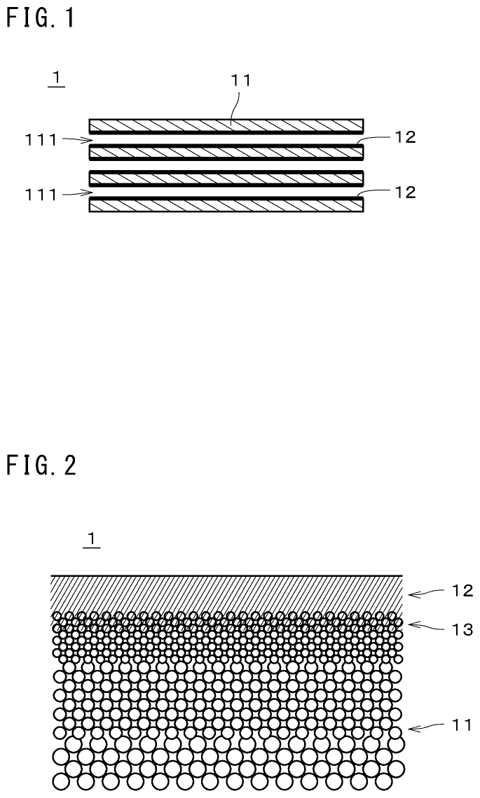

FIG. 1 is a sectional view of a separation membrane complex 1. FIG. 2 is an enlarged sectional view showing part of the separation membrane complex 1. The separation membrane complex 1 includes a support 11 that is porous and a separation membrane 12 formed on the support 11. As will be described later, the separation membrane 12 is a membrane of a metal organic framework (MOF) (hereinafter, also referred to as an “MOF membrane”) with an amine supported thereon, and the separation membrane complex 1 is an MOF membrane complex. The MOF membrane refers to at least a membrane obtained by forming an MOF in membrane form on a surface of the support 11, and does not include any membranes obtained by simply dispersing MOF particles in an organic membrane. In FIG. 1, the separation membrane 12 is illustrated with thick lines in an emphasized manner. In FIG. 2, hatching is given to the separation membrane 12. The separation membrane 12 in FIG. 2 is also illustrated thicker than its actual thickness.

The support 11 is a porous member that is permeable to gases and liquids. In the example shown in FIG. 1, the support 11 is a so-called monolith support in which a plurality of through holes 111, each extending in a longitudinal direction (i.e., the right-left direction in FIG. 1), are formed in an integrally-molded continuous column-like body. In the example shown in FIG. 1, the support 11 has an approximately column-like shape. Each through hole 111 (i.e., cell) has, for example, an approximately circular cross-sectional shape perpendicular to the longitudinal direction. In FIG. 1, the diameter of the through holes 111 is illustrated greater than the actual diameter, and the number of through holes 111 is illustrated smaller than the actual number. The separation membrane 12 is formed on the inner surfaces of the through holes 111 and covers approximately the entire inner surfaces of the through holes 111.

The length of the support 11 (i.e., the length in the right-left direction in FIG. 1) is in the range of, for example, 10 cm to 200 cm (here, “to” means values greater than or equal to the former value and less than or equal to the latter value). The outside diameter of the support 11 is in the range of, for example, 0.5 cm to 30 cm. The distance between the central axes of adjacent through holes 111 is in the range of, for example, 0.3 mm to 10 mm. Surface roughness (Ra) of the support 11 is in the range of, for example, 0.1 μm to 5.0 μm and preferably in the range of 0.2 μm to 2.0 μm. Note that the support 11 may have any other shape such as a honeycomb shape, a flat plate-like shape, a tube-like shape, a cylinder-like shape, a column-like shape, or a prism shape. In the case where the support 11 has a tube- or cylinder-like shape, the thickness of the support 11 is in the range of, for example, 0.1 mm to 10 mm.

The support 11 is formed of ceramic. Examples of a ceramic sintered body selected as the material for the support 11 include alumina, silica, mullite, zirconia, titania, yttria, silicon nitride, silicon carbide, and the like. In the present embodiment, the support 11 contains at least one type selected from among alumina, silica, and mullite. The support 11 may contain an inorganic binder. The inorganic binder to be used may be at least one of titania, mullite, easily sinterable alumina, silica, glass frit, clay minerals, and easily sinterable cordierite.

The support 11 has a mean pore diameter of, for example, 0.01 μm to 70 μm and preferably 0.05 μm to 25 μm. The mean pore diameter of the support 11 in the vicinity of the surface on which the separation membrane 12 is formed is in the range of 0.01 μm to 1 μm and preferably in the range of 0.05 μm to 0.5 μm. The mean pore diameter can be measured by, for example, a mercury porosimeter, a perm-porosimeter, or a nano-perm-porosimeter. As to the pore size distribution of the entire support 11 including the surface and the interior, D5 is in the range of, for example, 0.01 μm to 50 μm, D50 is in the range of, for example, 0.05 μm to 70 μm, and D95 is in the range of, for example, 0.1 μm to 2000 μm. The porosity of the support 11 in the vicinity of the surface on which the separation membrane 12 is formed is in the range of, for example, 20% to 60%. The porosity can be obtained as the ratio of areas where space exists in an SEM (scanning electron microscope) image of a section of the support 11.

For example, the support 11 has a multilayer structure in which a plurality of layers having different mean pore diameters are stacked one above another in the thickness direction. A mean pore diameter and a sintered particle diameter in the surface layer including the surface on which the separation membrane 12 is formed are smaller than those in layers other than the surface layer. The mean pore diameter in the surface layer of the support 11 is in the range of, for example, 0.01 μm to 1 μm and preferably in the range of 0.05 μm to 0.5 μm. In the case where the support 11 has a multilayer structure, any of the substances described above may be used as the material for each layer. The plurality of layers forming the multilayer structure may be made of the same material, or may be made of different materials. In the case where the support 11 has a multilayer structure, the mean pore diameter of the support 11 corresponds to the mean pore diameter in the surface layer including the surface on which the separation membrane 12 is formed.

The separation membrane 12 is a porous membrane having fine pores (micropores). The separation membrane 12 is capable of separating a specific substance from a mixture substance which is a mixture of a plurality of types of substances by using a molecular-sieving function or the like. The separation membrane 12 is less permeable to the other substances than to the specific substance. In other words, the permeance of the separation membrane 12 to the other substances is lower than the permeance of the separation membrane 12 to the aforementioned specific substance.

The separation membrane 12 has an average membrane thickness of less than or equal to 2 μm. This achieves high permeance. There are no particular limitations on the lower limit for the average membrane thickness of the separation membrane 12, but from the viewpoint of improving separation performance, the lower limit is preferably 0.5 μm and more preferably 0.7 μm. In the measurement of the average membrane thickness of the separation membrane 12, a section of the separation membrane 12 perpendicular to the surface thereof is exposed by, for example, cross-sectional polishing. In this section, a plurality of randomly determined fields of view (e.g., seven fields of view) are observed with an SEM. The SEM has a magnification of, for example, 5000×. The average membrane thickness (view-field average membrane thickness) of the separation membrane 12 in each field of view is obtained as an average value of membrane thicknesses at appropriately selected five locations, and an arithmetical mean of the view-field average membrane thicknesses in the remaining fields of view except the fields of view that give maximum and minimum view-field average membrane thicknesses is acquired as the average membrane thickness of the separation membrane 12. Surface roughness (Ra) of the separation membrane 12 is, for example, less than or equal to 2 μm, preferably less than or equal to 1 μm, and more preferably less than or equal to 0.5 μm.

A mean pore diameter of the MOF membrane configuring the separation membrane 12 is greater than or equal to 0.40 nm and less than or equal to 0.90 nm. The “mean pore diameter of the MOF” refers to an average value of the major and minor axes of pore openings derived theoretically from the framework structure of the MOF. Alternatively, the mean pore diameter may be obtained by acquiring the major and minor axes of pore openings by observation with a TEM (transmission electron microscope). To be precise, the major and minor axes of pore openings refer to lattice spacing of a lattice structure having high regularity and formed of metal ions and organic ligands. The MOF has a specific pore structure including a channel (pores) and a cage (internal space) according to the structure type. The pore diameter as used herein refers to the pore size of the channel, and an arithmetical mean of the major and minor axes is given as the mean pore diameter, where the major axis is a maximum diameter along a section of the channel, and the minor axis is the diameter of a section in a direction approximately perpendicular to the major axis. This mean pore diameter is smaller than the mean pore diameter of the support 11 in the vicinity of the surface on which the separation membrane 12 is formed.

A mean particle size of the MOF configuring the separation membrane 12, i.e., a mean diameter of crystal grains, is in the range of, for example, 0.1 μm to 2 μm. The mean particle size is preferably less than or equal to 1 μm and more preferably less than or equal to 0.5 μm. The separation membrane 12 with a small mean particle size of the MOF can reduce intergranular defects that may be caused by excessively large interstices between crystals of the MOF and can exhibit improved separation performance. The mean particle size of the MOF according to the present embodiment is an arithmetical mean of maximum diameters of a plurality of MOF particles (e.g., 30 particles) measured by observation of a membrane surface with an SEM. The particles to be measured may be randomly selected from an SEM image.

At the interface between the separation membrane 12 and the support 11, a composite layer 13 is formed, in which the crystals of the MOF become embedded in the pores of the support 11. FIG. 2 shows the composite layer 13 by drawing hatching over part of the support 11. The composite layer 13 is part of the support 11. The composite layer 13 has a thickness of, for example, less than or equal to 2 μm. This enables suppressing a decrease in permeance resulting from the presence of the composite layer 13. The composite layer 13 may be omitted, and a lower limit value for the thickness of the composite layer 13 is zero.

In the measurement of the thickness of the composite layer 13, a boundary position of the composite layer 13 in a direction perpendicular to the interface between the support 11 and the separation membrane 12 (hereinafter referred to as the “depth direction”) is identified in the vicinity of one measurement position in a direction along the interface during cross-section observation with an SEM. To be more specific, the boundary position of the composite layer 13 on the side closer to the separation membrane 12 corresponds to the interface between the separation membrane 12 and the support 11. The boundary position of the composite layer 13 on the side opposite to the separation membrane 12 corresponds to, in the MOF existing in the pores of the support 11, the edge of the MOF that is furthest from the separation membrane 12 in the depth direction. The distance in the depth direction between the boundary position of the composite layer 13 on the side closer to the separation membrane 12 and the boundary position thereof on the side opposite to the separation membrane 12 is acquired as the thickness of the composite layer 13 at the measurement position. Then, an average of the thicknesses of the composite layer 13 at a plurality of different measurement positions (e.g., 10 measurement positions) is determined as the thickness of the composite layer 13 in the separation membrane complex 1.

Not only in the case where the composite layer 13 does not exist, but also even in the case where the composite layer 13 exists, no additional intermediate layer is formed between the support 11 and the separation membrane 12 in the separation membrane complex 1. Thus, the support 11 and the separation membrane 12 are in direct contact with each other. That is, there are no intermediate layers formed between the support 11 and the separation membrane 12 in any step other than the step of forming the MOF membrane.

The MOF configuring the separation membrane 12 consists of metal ions and an organic ligand (hereinafter, simply referred to as a “ligand”) that coordinates with the metal ions. In practical use, the metal ions serving as a component of the MOF are preferably at least one selected from the group consisting of Al³⁺, Co³⁺, Co²⁺, Ni²⁺, Ni⁺, Cu²⁺, Cu⁺, Zn²⁺, Fe³⁺, Fe²⁺, Ti³⁺, and Zr⁴⁺. More preferably, the metal ions are at least one selected from the group consisting of Al³⁺, Zn²⁺, Ti³⁺, and Zr⁴⁺. The number of types of metal ions contained in the MOF is preferably singular, but may be plural.

The ligand serving as a component of the MOF is preferably a bidentate ligand that is an organic molecular ion having two carboxy groups. This facilitates the formation of pores that are more permeable to a specific gas than to other specific gases. There are no particular limitations on the structure other than the two carboxy groups, but as one preferable example, the ligand includes a heterocycle. The ligand may include, instead of the carboxy groups, other ligands such as a pyridine group or a pyrrole group that can coordinate with the metal ions.

The separation membrane 12 is configured by the MOF with an amine supported thereon. That is, the separation membrane 12 is an MOF membrane with an amine supported thereon. Here, “with an amine supported thereon” means that amine molecules exist in contact with the framework of the MOS, and means that the amine adheres to the MOF with just enough force to prevent easy amine liberation from the framework of the MOS when a gas that will permeate the separation membrane 12 is permeating the inside of the MOS. This state may be expressed as “the amine is introduced into the MOF membrane” or the “MOF membrane is modified by the amine”. At least the amine is supported on the surface of the MOF membrane and in the pores of the MOF membrane in the vicinity of the surface.

Preferably, the abundance of the amine gradually decreases from the surface of the MOF membrane (the surface on the side opposite to the support 11) toward the support 11. Here, “gradually decreases” expresses a state in overall view and eliminates slight increases and decreases in microscopic view. As will be described later, the amine is preferably a normal amine. The normal amine supported on the MOF is not limited to one type, and may include one or more types of normal amines. Preferably, no amine exists within the support 11 (this includes the case where the amine exists slightly without intention), and more preferably, no amine exists even in the interior of the MOF membrane in the vicinity of the support 11 (this includes the case where the amine exists slightly without intention).

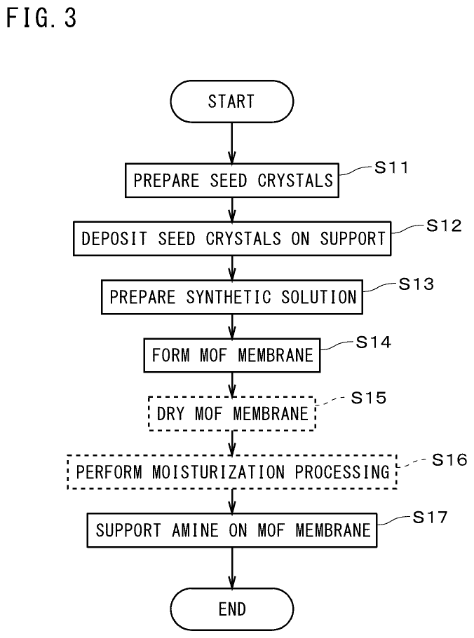

Next, a procedure for producing the separation membrane complex 1 will be described with reference to FIG. 3. In the production of the separation membrane complex 1, firstly, seed crystals are prepared for use in the production of the MOF membrane serving as the framework of the separation membrane 12 (step S11). For example, the seed crystals are generated as MOF powder by Solvothermal synthesis using water and/or an organic solvent (also referred to as hydrothermal synthesis when water is used as a solvent). The MOF powder may be generated by any other arbitrarily or known production method. The MOF powder may be used as-is as the seed crystals, or may be processed by pulverization or the like to acquire more preferable seed crystals.

A mean particle size (D50) of the seed crystals is preferably less than or equal to 0.5 μm. This allows the MOF membrane to suppress the generation of intergranular defects which are caused by an excessive increase in the mean particle size of the MOF. There are no particular limitations on the lower limit for the mean particle size of the seed crystals, but for example if the mean particle size is made greater than or equal to 0.1 μm, it is possible to suppress deterioration in crystallinity of the seed crystals. The mean particle size (D50) of the seed crystals can measured by, for example, a laser scattering method.

Then, the seed crystals are dispersed in a solvent (water and/or an organic solvent) to produce a dispersion in an amount of 0.01 w % to 1 w %. The porous support 11 is immersed in the dispersion so that the seed crystals are deposited on the support 11 (dip coating method) (step S12). Alternatively, the dispersion with the seed crystals dispersed in the solvent is brought into contact with a portion of the support 11 where the separation membrane 12 is to be formed, in order to make the seed crystals deposited on the support 11. Thereafter, the solvent is removed by drying to prepare a seed-crystal-deposited support. The seed crystals may be deposited on the support 11 by any other technique.

Then, a starting material solution (also referred to as synthetic sol or a synthetic solution) is confected and prepared for use in the formation of the MOF membrane (step S13). The confection of the starting material solution may be conducted before step S12 or in parallel with step S12. In the confection of the starting material solution, a solvent (water and/or organic solvent), ligands, a metal ion source, and other starting materials are mixed together. Specifically, ligands are added to and dissolved in the solvent by ultrasonication or heating in a thermostatic chamber. Thereafter, the metal ions are added to the solvent to produce the starting material solution.

When the starting material solution has been prepared, the support 11 with the seed crystals deposited thereon is immersed in the starting material solution. Thereafter, the starting material solution is heated to start Solvothermal synthesis involving hydrothermal synthesis (hereinafter, collectively referred to as “Solvothermal synthesis”). In the Solvothermal synthesis, the seed crystals are used as nuclei, and the MOF having a mean pore diameter of greater than or equal to 0.40 nm and less than or equal to 0.90 nm is grown into a dense MOF membrane serving as a basic structure of the separation membrane 12 on the support 11 (step S14). The synthesis temperature during the Solvothermal synthesis (the heating temperature of the starting material solution) is in the range of, for example, 40° C. to 200° C. and preferably in the range of 70° C. to 150° C. The Solvothermal synthesis time is in the range of, for example, 1 hour to 100 hours and preferably in the range of 1 hour to 50 hours.

After the Solvothermal synthesis ends, the support 11 and the MOF membrane are cleaned with pure water and then they are cleaned with ethanol or the like. Preferably, the cleaning with water and ethanol or the like is repeated a plurality of times. The support 11 and the MOF membrane after cleaning are dried at, for example, 100° C. (step S15). Here, “dried” refers to removing molecules of substances used for cleaning, such as water and ethanol or the like, from the inside of the pores of the MOF membrane.

Then, moisturization processing is performed in which the MOF membrane is kept in a high-humidity environment (step S16). Here, the MOF membrane is “kept in a high-humidity environment” means that the MOF membrane is located in a high-humidity environment (atmosphere). “High humidity” means that humidity is high relative to a relatively dry environment in which experiment or the like is conducted, and does not mean high humidity in a natural environment. In the high-humidity environment, gases around the MOF membrane may flow, or may not flow. The moisturization processing refers to processing for substantially bringing water vapor into contact with the MOF membrane. The moisturization processing is not an absolute necessity, but it is thought that the moisturization processing allows the amount of the amine supported on the MOF membrane to gradually decrease from the surface of the MOF membrane toward the support 11 during subsequent amine-support treatment, and thereby prevents an excessive amount of the amine from being supported on the MOF membrane. This achieves both high gas separation performance and high gas permeance.

In the moisturization processing, the MOF membrane is kept in an environment with a temperature of higher than or equal to 10° C. and lower than or equal to 80° C., preferably a temperature of higher than or equal to 20° C. and lower than or equal to 50° C. that is close to room temperature, and with a humidity of higher than or equal to 30% (preferably higher than or equal to 40%) and lower than or equal to 100% for 0.5 hours or more, preferably one hour or more, and more preferably three hours or more (preferably 10 hours or less).

Then, an amine-containing solution is brought into contact with a surface of the MOF membrane so that the amine is supported on the MOF membrane (step S17). That is, the amine exists on the surface of the MOF membrane and in the pores of the MOF membrane. To be more specific, the amine-containing solution is brought into contact with only the surface of the MOF membrane on the side opposite to the support 11, so that the amine is supported on the surface of the MOF membrane and inside the MOF membrane in the vicinity of that surface. The concentration of the amine in the solution where the amine dissolved in an organic solvent is higher than or equal to 0.001 mol/L and lower than or equal to 1 mol/L. More preferably, the concentration of the amine is higher than or equal to 0.05 mol/L and lower than or equal to 0.5 mol/L. The phrase “an amine-containing solution is “brought into contact” with a surface of the MOF membrane” means that the solution exists on that surface. It is preferable that the amine-containing solution exists on that surface for a predetermined period of time or more, and the phrase “brought into contact” means that the surface is wet with the amine-containing solution when viewed locally.

Amine-support treatment is conducted in a kindly environment at a temperature of higher than or equal to 10° C. and lower than or equal to 60° C. Preferably, the amine-support treatment is conducted at a temperature of higher than or equal to 20° C. and lower than or equal to 40° C. More preferably, the amine-support treatment is conducted at room temperature. This allows the treatment to be conducted more safely than in the case of using dangerous conventional technique in which an amine is supported at high temperatures on a zeolite membrane or a mesoporous silica membrane by using an organic solvent. The amine-support treatment time is preferably longer than or equal to 1 hour and shorter than or equal to 72 hours, and more preferably longer than or equal to 5 hours and shorter than or equal to 30 hours.

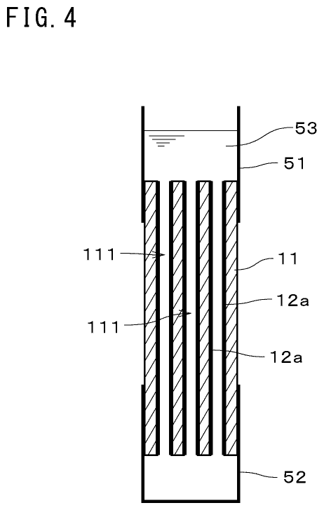

Specifically, as shown in FIG. 4, the support 11 is arranged such that the through holes 111 are aligned in parallel with the direction of gravity, and silicone tubes 51 and 52 are connected respectively to the upper and lower end faces of the support 11. The tube 52 has a closed bottom. The tubes 51 and 52 are filled with an amine-containing solution 53, so that the inner surfaces of the through holes 111 of the support 11 come in contact with the solution. As a result, only the surface of an MOF membrane 12a on one side (the surface on the side opposite to the support 11) comes in contact with the solution, and the amine is introduced on the surface of the MOF membrane 12a on the one side and in the MOF membrane 12a in the vicinity of that surface. Note that the tubes 51 and 52 may configure a single tube that covers the entire outer surface of the support 11.

Thereafter, the MOF membrane 12a is dried to become the ultimate separation membrane 12. The separation membrane 12 contains the amine existing on the surface thereof and in the interior thereof in the vicinity of that surface. More preferably, the density of the amine in the MOF membrane gradually decreases from the surface toward the support 11. Preferably, no amine exists within the support 11 (this includes the case where the amine exists slightly without intention), and more preferably, no amine exists even in the interior of the MOF membrane in the vicinity of the support 11 (this includes the case where the amine exists slightly without intension). Through the treatment described above, the separation membrane complex 1 is obtained.

The amine used in the amine-support treatment, i.e., an amine source in the solution, is preferably a normal amine. The term “normal” means that carbon atoms forming hydrocarbon or a derivative thereof are bonded in a single chain without forming any ring structure or any branched structure. The normal amine preferably has one or more and six or less amino groups, and the number of nitrogen atoms and carbon atoms connected in a chain is preferably greater than or equal to two and less than or equal to 30. It is thought that the use of the normal amine facilitates the introduction of the amine into the pores of the MOF membrane 12a. It is also thought that the use of the normal amine prevents blockages of the pores of the MOF and achieves high gas permeability.

The presence of the amine in the separation membrane 12 can be checked by, for example, TOF-SIMS-depth (“TOF-SIMS” is an abbreviation of “Time-of-Flight Secondary Ion Mass Spectrometry”). The amount of the amine supported, i.e., the abundance of the amine per unit volume, can be measured by measuring N elements (nitrogen elements). In TOF-SIMS-depth, the concentration of the N elements is measured in the depth direction from the surface of the separation membrane 12. As a result of the measurement, it is confirmed that the concentration of the N elements in the separation membrane 12 gradually decreases from the surface toward the support 11. That is, the abundance of the amine per unit volume gradually decreases from the surface of the separation membrane 12 toward the support 11. Note that, because of the influence of contamination, the concentration of the N elements in close vicinity of the surface of the separation membrane 12 may be ignored.

In the separation membrane complex 1, the amine is not chemically bonded to the MOF membrane. Thus, in the case where the amine becomes deteriorated, it is possible to remove the amine from the MOF membrane by using a solvent in order to again allow the support of a new amine.

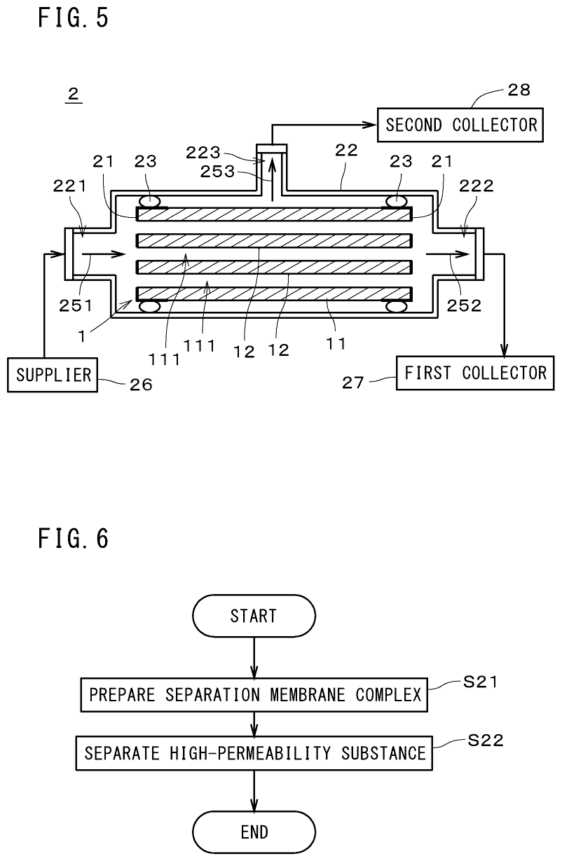

Next, the separation of a mixture of substances using the separation membrane complex 1 will be described with reference to FIGS. 5 and 6. FIG. 5 is a diagram showing a separation apparatus 2. FIG. 6 is a flowchart showing the separation of a mixture of substances by the separation apparatus 2.

The separation apparatus 2 supplies a mixture of substances including a plurality of types of fluid (i.e., gases or liquids) to the separation membrane complex 1 and causes a substance with high permeability in the mixture of substances to permeate the separation membrane complex 1 in order to separate the substance having high permeability from the mixture of substances. For example, the separation by the separation apparatus 2 may be performed for the purpose of extracting a substance with high permeability from the mixture of substances or for the purpose of condensing a substance with low permeability.

The mixture of substances (i.e., a fluid mixture) may be a mixed gas that contains a plurality of types of gases, a mixed solution that contains a plurality of types of liquids, or a gas-liquid two-phase fluid that contains both a gas and a liquid.

For example, the mixture of substances contain one or more types of substances selected from among hydrogen (H₂), helium (He), nitrogen (N₂), oxygen (O₂), water (H₂O), carbon monoxide (CO), carbon dioxide (CO₂), nitrogen oxide, ammonia (NH₃), sulfur oxide, hydrogen sulfide (H₂S), sulfur fluorides, mercury (Hg), arsine (AsH₃), hydrogen cyanide (HCN), carbonyl sulfide (COS), C1 to C8 hydrocarbons, organic acid, alcohol, mercaptan, ester, ether, ketone, and aldehyde.

Nitrogen oxide is a compound of nitrogen and oxygen. For example, the aforementioned nitrogen oxide is a gas called NOx such as nitrogen monoxide (NO), nitrogen dioxide (NO₂), nitrous oxide (also referred to as dinitrogen monoxide) (N₂O), dinitrogen trioxide (N₂O₃), dinitrogen tetroxide (N₂O₄), or dinitrogen pentoxide (N₂O₅).

Sulfur oxide is a compound of sulfur and oxygen. For example, the aforementioned sulfur oxide is a gas called SOₓ such as sulfur dioxide (SO₂) or sulfur trioxide (SO₃).

Sulfur fluorides is a compound of fluorine and sulfur. For example, the aforementioned sulfur fluorides is disulfur difluoride (F—S—S—F, S=SF₂), sulfur difluoride (SF₂), sulfur tetrafluoride (SF₄), sulfur hexafluoride (SF₆), disulfur decafluoride (S₂F₁₀), or the like.

C1 to C8 hydrocarbons are hydrocarbons that contain one or more and eight or less carbon atoms. C3 to C8 hydrocarbons may be any of linear-chain compounds, side-chain compounds, and cyclic compounds. C2 to C8 hydrocarbons each may be one of saturated hydrocarbons (i.e., where neither double bonds nor triple bonds exist in molecules) and unsaturated hydrocarbons (i.e., where double bonds and/or triple bonds exist in molecules). C1 to C4 hydrocarbons are, for example, methane (CH₄), ethane (C₂H₆), ethylene (C₂H₄), propane (C₃H₈), propylene (C₃H₆), normal butane (CH₃(CH₂)₂CH₃), isobutene (CH(CH₃)₃), 1-butene (CH₂═CHCH₂CH₃), 2-butene (CH₃CH═CHCH₃), or isobutene (CH₂═C(CH₃)₂).

The aforementioned organic acid is carboxylic acid or sulfonic acid, or the like. The carboxylic acid is, for example, formic acid (CH₂O₂), acetic acid (C₂H₄O₂), oxalic acid (C₂H₂O₄), acrylic acid (C₃H₄O₂), benzoic acid (C₆H₅COOH), or the like. The sulfonic acid is, for example, ethane sulfonic acid (C₂H₆O₃S), or the like. The organic acid may be either a chain compound or a cyclic compound.

The aforementioned alcohol is, for example, methanol (CH₃OH), ethanol (C₂H₅OH), isopropanol (2-propanol) (CH₃CH(OH)CH₃), ethylene glycol (CH₂(OH)CH₂(OH)), butanol (C₄H₉OH), or the like.

Mercaptan is an organic compound with terminal sulfur hydrides (SH) and is also a substance called thiol or thioalcohol. The aforementioned mercaptan is, for example, methyl mercaptan (CH₃SH), ethyl mercaptan (C₂H₅SH), 1-propane thiol (C₃H₇SH), or the like.

The aforementioned ester is, for example, formic acid ester, acetic acid ester, or the like.

The aforementioned ether is, for example, dimethyl ether ((CH₃)₂O), methyl ethyl ether (C₂H₅OCH₃), diethyl ether ((C₂H₅)₂O), or the like.

The aforementioned ketone is, for example, acetone ((CH₃)₂CO), methyl ethyl ketone (C₂H₅COCH₃), diethyl ketone ((C₂H₅)₂CO), or the like.

The aforementioned aldehyde is, for example, acetaldehyde (CH₃CHO), propionaldehyde (C₂H₅CHO), butanal (butyraldehyde) (C₃H₇CHO), or the like.

The following description is given on the assumption that a mixture of substances to be separated by the separation apparatus 2 is a mixed gas that contains a plurality of types of gases.

The separation apparatus 2 includes the separation membrane complex 1, sealers 21, a housing 22, two seal members 23, a supplier 26, a first collector 27, and a second collector 28. The separation membrane complex 1, the sealers 21, and the seal members 23 are placed in the housing 22. The supplier 26, the first collector 27, and the second collector 28 are arranged outside the housing 22 and connected to the housing 22.

The sealers 21 are members that are attached to both ends of the support 11 in the longitudinal direction (i.e., the right-left direction in FIG. 5) and cover and seal both end faces of the support 11 in the longitudinal direction and the outer surfaces thereof in the vicinity of the both end faces. The sealers 21 prevent inflow and outflow of gases from the both end faces of the support 11. For example, the sealers 21 may be plate-like members formed of glass or a resin. The material and shape of the sealers 21 may be changed as appropriate. Note that the sealers 21 have a plurality of openings that overlap the through holes 111 of the support 11, so that both ends of each through hole 111 of the support 11 in the longitudinal direction are not covered with the sealers 21. This allows the inflow and outflow of gases or the like from the both ends into and out of the through holes 111.

There are no particular limitations on the shape of the housing 22, and for example, the housing 22 is an approximately cylinder-like tubular member. The housing 22 is formed of, for example, stainless steel or carbon steel. The longitudinal direction of the housing 22 is approximately parallel to the longitudinal direction of the separation membrane complex 1. One end of the housing 22 in the longitudinal direction (i.e., the left end in FIG. 5) is provided with a supply port 221, and the other end thereof is provided with a first exhaust port 222. The side face of the housing 22 is provided with a second exhaust port 223. The supply port 221 is connected to the supplier 26. The first exhaust port 222 is connected to the first collector 27. The second exhaust port 223 is connected to the second collector 28. The internal space of the housing 22 is an enclosed space isolated from the space around the housing 22.

The two seal members 23 are arranged around the entire circumference between the outer surface of the separation membrane complex 1 and the inner surface of the housing 22 in the vicinity of the both ends of the separation membrane complex 1 in the longitudinal direction. Each seal member 23 is an approximately ring-shaped member formed of a material that is impermeable to gases. For example, the seal members 23 may be O-rings formed of a resin having flexibility. The seal members 23 are in tight contact with the outer surface of the separation membrane complex 1 and the inner surface of the housing 22 along the entire circumference. In the example shown in FIG. 5, the seal members 23 are in tight contact with the outer surface of the sealers 21 and are in indirect tight contact with the outer surface of the separation membrane complex 1 via the sealers 21. The space between the seal members 23 and the outer surface of the separation membrane complex 1 and the space between the seal members 23 and the inner surface of the housing 22 are sealed so as to almost or completely disable the passage of gases.

The supplier 26 supplies a mixed gas to the internal space of the housing 22 via the supply port 221. For example, the supplier 26 is configured by a blower or a pump that sends the mixed gas toward the housing 22 under pressure. The blower or the pump includes a pressure regulator that regulates the pressure of the mixed gas supplied to the housing 22. The first collector 27 and the second collector 28 are, for example, reservoirs that stores gases derived from the housing 22, or a blower or pump that transfers the gases.

In the separation of the mixed gas, the above-described separation apparatus 2 is prepared for the preparation of the separation membrane complex 1 (step S21). Then, the supplier 26 supplies a mixed gas to the internal space of the housing 22, the mixed gas containing a plurality of types of gases each having different permeability through the separation membrane 12. For example, principal components of the mixed gas are CO₂ and N₂. The mixed gas may further contain a gas other than CO₂ and N₂. The pressure of the mixed gas supplied from the supplier 26 to the internal space of the housing 22 (i.e., introducing pressure) is in the range of, for example, 0.1 MPa to 20.0 MPa, and the temperature during the separation of the mixed gas is in the range of, for example, 10° C. to 150° C.

The mixed gas supplied from the supplier 26 to the housing 22 is introduced from the left end of the separation membrane complex 1 in the drawing into each through hole 111 of the support 11 as indicated by an arrow 251. A gas with high permeability in the mixed gas (e.g., CO₂; hereinafter referred to as a “high-permeability substance”) permeates the separation membrane 12 provided on the inner surface of each through hole 111 and then permeates the support 11 so as to be derived from the outer surface of the support 11. Accordingly, the high-permeability substance is separated from a gas with low permeability in the mixed gas (e.g., N₂; hereinafter referred to as a “low-permeability substance”) (step S22). The gas derived from the outer surface of the support 11 (hereinafter, referred to as a “permeated substance”) is collected by the second collector 28 via the second exhaust port 223 as indicated by an arrow 253. The pressure of the gas collected by the second collector 28 via the second exhaust port 223 (i.e., permeate pressure) is, for example, approximately one atmospheric pressure (0.101 MPa).

In the mixed gas, gases (hereinafter, referred to as “non-permeated substances”) other than the gas that has permeated the separation membrane 12 and the support 11 pass through each through hole 111 of the support 11 from the left side to the right side in the drawing and is collected by the first collector 27 via the first exhaust port 222 as indicated by an arrow 252. The pressure of the gas collected by the first collector 27 via the first exhaust port 222 is, for example, approximately the same as the introducing pressure. The non-permeated substances may include a high-permeability substance that has not permeated the separation membrane 12, in addition to the aforementioned low-permeability substance.

In order to use the separation membrane complex 1 for the separation of a gas, the permeance of a high-permeability substance is preferably five times or more the permeance of a low-permeability substance. The permeance refers to the transmission rate of a gas per unit membrane area and per unit pressure difference. In the case where the separation membrane complex 1 includes the separation membrane 12 with the amine supported thereon, the separation membrane complex 1 is at least suitable for the separation of CO₂, and the ratio of permeance of CO₂ serving as a high-permeability substance to permeance of a target gas to be separated (i.e., a low-permeability substance such as N₂) is preferably higher than or equal to five. In particular, in the case where the target gas is N₂, as will be clear in examples described later, the ratio of permeance of CO₂ to permeance of N₂ is preferably higher than or equal to 10 and more preferably higher than or equal to 30.

Next, examples and comparative examples of the separation membrane complex will be described. Table I shows production conditions and measurement results for the examples and the comparative examples.

TABLE 1

| | | | | | Moisturization | Amine-Support | |
|---|---|---|---|---|---|---|---|
| | | MOF | Mean Pore | | Conditions | Conditions | CO₂/N₂ |
| | | Membrane | Diameter | | Temperature, | Concentration, | Permeance |
| | MOF Type | (μm) | of MOF (nm) | Amine | Humidity, Time | Time | Ratio |
| Example 1 | Al Fumarate | 1.8 | 0.59 | tetraethylenepentamine | 25° C., 50%, 72 h | 0.1 mol/L, 24 h | 55 |
| Example 2 | Al Fumarate | 1.8 | 0.59 | tetraethylenepentamine | 50° C., 20%, 0.5 h | 0.1 mol/L, 24 h | 50 |
| Example 3 | Al Fumarate | 1.8 | 0.59 | tetraethylenepentamine | 30° C., 90%, 24 h | 0.1 mol/L, 24 h | 55 |
| Example 4 | Al Fumarate | 1.8 | 0.59 | tetraethylenepentamine | 25° C., 50%, 72 h | 0.1 mol/L, 2 h | 40 |
| Example 5 | Al Fumarate | 1.8 | 0.59 | tetraethylenepentamine | 25° C., 50%, 72 h | 0.1 mol/L, 72 h | 60 |
| Example 6 | Al Fumarate | 1.8 | 0.59 | ethylenediamine | 25° C., 50%, 72 h | 0.1 mol/L, 24 h | 40 |
| Example 7 | Al Fumarate | 1.8 | 0.59 | 2-(2-aminoethylamino)ethanol | 25° C., 50%, 72 h | 0.1 mol/L, 24 h | 60 |
| Example 8 | Al Fumarate | 1.8 | 0.59 | diethylenetriamine | 25° C., 50%, 72 h | 0.1 mol/L, 24 h | 40 |
| Example 9 | Al Fumarate | 1.0 | 0.59 | tetraethylenepentamine | 30° C., 80%, 12 h | 0.1 mol/L, 24 h | 55 |
| Example 10 | Al Fumarate | 1.8 | 0.59 | tetraethylenepentamine | — | 0.1 mol/L, 24 h | 15 |
| Example 11 | KMF-1 | 1.2 | 0.60 | tetraethylenepentamine | 25° C., 50%, 72 h | 0.1 mol/L, 24 h | 25 |
| Example 12 | KMF-1 | 1.2 | 0.60 | 2-(2-aminoethylamino)ethanol | 25° C., 50%, 72 h | 0.1 mol/L, 24 h | 30 |
| Example 13 | MIL-125-NH₂(Ti) | 2.0 | 0.60 | tetraethylenepentamine | 25° C., 50%, 72 h | 0.1 mol/L, 24 h | 10 |
| Example 14 | UiO-66-NH₂(Zr) | 2.0 | 0.60 | tetraethylenepentamine | 25° C., 50%, 72 h | 0.1 mol/L, 24 h | 16 |
| Example 15 | CAU-10-H | 1.0 | 0.40 | tetraethylenepentamine | 25° C., 50%, 72 h | 0.1 mol/L, 24 h | 30 |
| Example 16 | Al Fumarate | 1.8 | 0.59 | tetraethylenepentamine | 25° C., 50%, 72 h | 0.1 mol/L, 24 h | 10 |
| | | | | | | (Overall | |
| | | | | | | Immersion) | |
| Comparative | Al Fumarate | 1.8 | 0.60 | — | — | — | 3 |
| Example 1 | | | | | | | |
| Comparative | Mg-MOF-74 | 5.0 | 1.10 | tetraethylenepentamine | 25° C., 50%, 72 h | 0.1 mol/L, 24 h | 0.5 |
| Example 2 | | | | | | | |

First, the generation of four types of seed crystals used in the examples and the comparative examples will be described. One of the four types of seed crystals was used in each of the examples and the comparative examples.

### Preparation of Seed Crystals of Al Fumarate

An MOF called “Al fumarate” is known from “Fast synthesis of Al fumarate metal-organic framework as a novel tetraethylenepentamine support for efficient CO₂ capture”, by Qiwei Liua and other five members, Colloids and Surfaces A, 579 (2019) 123645. First, 0.28 g of fumaric acid serving as ligands and 0.34 g of sodium formate were added to 50 mL of deionized water to prepare a mixed solution. After three-hour agitation at 50° C., the mixed solution was cooled down to room temperature, and 0.83 g of aluminum sulfate octadecahydrate serving as a metal ion source was added to the mixed solution. Then, the resultant solution was subjected Solvothermal synthesis conducted at 120° C. for 12 hours. Precipitates were separated from the solution by a centrifugal separator and cleaned with deionized water and ethanol three times. Through the above process, MOF powder was obtained as seed crystals of Al fumarate.

### Preparation of Seed Crystals of KMF-1

An MOF called “KMF-1” is known from “Rational design of a robust aluminum metal-organic framework for multi-purpose water-sorption-driven heat allocations”, by Kyung Ho Cho and other eleventh members, NATURE COMMUNICATIONS, (2020) 11:5112, (https://doi.org/10.1038/s41467-020-18968-7). First, 1.551 g of 1H-pyrrole-2,5-dicarboxylic acid serving as ligands and 1.36 g of sodium formate were added to 50 mL of deionized water to prepare a mixed solution. After three-hour agitation at 50° C., the mixed solution was cooled down to room temperature, and 3.333 g of aluminum sulfate octadecahydrate serving as a metal ion source was added to the mixed solution. Then, the resultant solution was subjected to Solvothermal synthesis conducted at 120° C. for 12 hours. Precipitates were separated from the solution by a centrifugal separator and cleaned with deionized water and ethanol three times. Through the above process, MOF powder was obtained as seed crystals of KMF-1.

### Preparation of Seed Crystals of MIL-125-NH₂ (Ti)

An MOF called “MIL-125-NH₂ (Ti)” is known from “NH₂-MIL-53 (Al) Metal-Organic Framework as the Smart Platform for Simultaneous High-Performance Detection and Removal of Hg²⁺”, by Liang Zhang and other nine members, Inorganic Chemistry 2019 58 (19), 12573-12581 (https://doi.org/10.1021/acs.inorgchem.9b01242). First, 2.0 mL of titanium tetra-isopropoxide serving as a metal ion source and 1.36 g of 2-amino-terephthalic acid serving as a ligand were added to a mixed solvent of 9 mL of dimethylformamide (DMF) and 1 mL of dry methanol to prepare a mixed solution. The mixed solution was agitated at room temperature for one hour. Then, the resultant solution was subjected to Solvothermal synthesis conducted at 150° C. for 72 hours. Precipitates were separated from the solution by a centrifugal separator and cleaned with deionized water and ethanol three times. Through the above process, MOF powder was obtained as seed crystals of MIL-125-NH₂ (Ti).

### Preparation of Seed Crystals of UiO-66-NH₂ (Zr)

An MOF called “UiO-66-NH₂ (Zr)” is also disclosed in the above document (by Liang Zhang and other nine members). First, 0.233 g of zirconium chloride serving as a metal ion source and 0.166 g of 2-amino-terephthalic acid serving as a ligand were added to a mixed solvent of 3 mL of acetic acid and 30 mL of DMF to prepare a mixed solution. The mixed solution was subjected to ultrasonication conducted at room temperature for 30 minutes. Then, the resultant solution was subjected to Solvothermal synthesis conducted at 120° C. for 24 hours. Precipitates were separated from the solution by a centrifugal separator and cleaned with deionized water and ethanol three times. Through the above process, MOF powder was obtained as seed crystals of UiO-66-NH₂ (Zr).

### Preparation of Seed Crystals of CAU-10-H

An MOF called “CAU-10-H” is known from “CO₂ adsorption under humid conditions: Self-regulated water content in CAU-10”, by V. B. Lopez-Cervantes and other five members, Polyhedron 155 (2018) 163-169. First, 1.666 g of aluminum sulfate octadecahydrate serving as a metal ion source and 0.415 g of trimeric acid serving as a ligand were added to a mixed solvent of 36 mL of DMF and 144 mL of water to prepare a mixed solution. The mixed solution was subjected to ultrasonication conducted at room temperature for 30 minutes. Then, the resultant solution was subjected to Solvothermal synthesis conducted at 135° C. for 24 hours. Precipitates were separated from the solution by a centrifugal separator and cleaned with deionized water and ethanol three times. Through the above process, MOF powder was obtained as seed crystals of CAU-10-H.

### Example 1

### Support of Seed Crystals

1 g of the seed crystals of Al fumarate was dispersed in 10 ml of ethanol serving as a dispersion medium and pulverized in a ball mill for 24 hours to obtain a dispersion of the seed crystals having a mean particle diameter (D50) of 250 nm. Thereafter, ethanol was added until the concentration of the dispersion became 0.01%. A porous alumina support was immersed in the dispersion to make the dispersion adhere to the support, and the solvent was vaporized in a dryer so that the seed crystals are supported on the surface of the support. The support used here had a mean pore diameter of approximately 100 nm.

### Generation of MOF Membrane

First, 0.39 g of fumaric acid and 0.45 g of sodium formate serving as ligands were added to 150 mL of deionized water to prepare a mixed solution. After the mixed solution was heated to 40° C. and agitated for one hour and the mixed solution was confirmed to have become transparent, the mixed solution was cooled down to room temperature, and 1.10 g of aluminum sulfate octadecahydrate serving as a metal ion source was added to the mixed solution to prepare a starting material solution. Then, the starting material solution and the support with the seed crystals supported thereon were placed in a Teflon (registered trademark) vessel and subjected to Solvothermal synthesis conducted at 100° C. for 20 hours to obtain an MOF membrane complex with an MOF membrane formed on the support. This MOF membrane complex was cleaned with deionized water and ethanol three times. Thereafter, the MOF membrane complex was dried in the atmosphere for 12 hours or more and then dried at 100° C. for 12 hours.

### Moisturization Processing

The MOF membrane complex was arranged in a constant temperature and humidity dryer and subjected to moisturization processing conducted at a temperature of 25° C. and a relative humidity of 50% for 72 hours.

### Amine-Support Treatment

Tetraethylenepentamine (TEPA) serving as an amine source was added to 30 mL of ethanol, and a resultant solution was agitated for 10 minutes to prepare 0.1 mol/L of an amine-containing ethanol solution. Silicone tubes were connected to the MOF complex (see FIG. 4), and the amine-containing ethanol solution was brought into contact with only the membrane surface of the MOF for 24 hours. Thereafter, the membrane surface was cleaned with only ethanol three times and dried at 100° C. for 12 hours so that the amine was supported on the MOF membrane. Through the above treatment, a separation membrane complex was obtained.

### Result of Measuring Membrane Thickness

A longitudinal section of the MOF membrane was observed randomly in seven fields of view with an SEM (scanning electron microscope), and as described previously, an average membrane thickness of the MOF membrane in each field image (view-field average membrane thickness) was obtained. Then, an arithmetical mean of view-field average membrane thicknesses obtained from five fields of view except the two fields of view that gave maximum and minimum values for the view-field average membrane thickness, as an average membrane thickness of the MOF membrane. The same also applies to the examples and the comparative examples described below.

As a result of measuring the average membrane thickness of the MOF membrane according to Example 1 by the above technique, the average membrane thickness was 1.8 μm.

Result of Measuring CO₂/N₂ Permeance Ratio

A CO₂/N₂ permeance ratio (the permeance ratio of CO₂ to N₂) was measured because the amine had the property of adsorbing CO₂ and the separation membrane with the amine supported thereon was suitable for the separation of CO₂. Here, CO₂ permeance and N₂ permeance were measured by introducing a gas to be measured into the surface of the separation membrane at 100° C. and with a pressure of 0.3 MPa. The CO₂/N₂ permeance ratio was obtained from the CO₂ permeance and the N₂ permeance. The same also applies to the examples and the comparative examples described below.

As a result of measuring the CO₂/N₂ permeance ratio according to Example 1 by the above technique, the permeance ratio was 55.

### Example 2

Processing conditions used in Example 2 were the same as those in Example 1, except that conditions for the moisturization processing were a temperature of 50° C., a relative humidity of 20%, and a treatment time of 0.5 hours. Thus, the average membrane thickness of the MOF membrane was the same as in Example 1. The CO₂/N₂ permeance ratio was 50.

### Example 3

Processing conditions used in Example 3 were the same as those in Example 1, except that conditions for the moisturization processing were a temperature of 30° C., a relative humidity of 90%, and a treatment time of 24 hours. Thus, the average membrane thickness of the MOF membrane was the same as in Example 1. The CO₂/N₂ permeance ratio was 55.

### Example 4

Processing conditions used in Example 4 were the same as those in Example 1, except that the MOF membrane complex was in contact with the amine-containing ethanol solution for two hours during the amine-support treatment. Thus, the average membrane thickness of the MOF membrane was the same as in Example 1. The CO₂/N₂ permeance ratio was 40.

### Example 5

Processing conditions used in Example 5 were the same as those in Example 1, except that the MOF membrane complex was in contact with the amine-containing ethanol solution for 72 hours during the amine-support treatment. Thus, the average membrane thickness of the MOF membrane was the same as in Example 1. The CO₂/N₂ permeance ratio was 60.

### Example 6

Processing conditions used in Example 6 were the same as those in Example 1, except that ethylenediamine was used as an amine source during the amine-support treatment. Thus, the average membrane thickness of the MOF membrane was the same as in Example 1. The CO₂/N₂ permeance ratio was 40.

### Example 7

Processing conditions used in Example 7 were the same as those in Example 1, except that 2-(2-aminoethylamino) ethanol was used as an amine source during the amine-support treatment. Thus, the average membrane thickness of the MOF membrane was the same as in Example 1. The CO₂/N₂ permeance ratio was 60.

### Example 8

Processing conditions used in Example 8 were the same as those in Example 1, except that diethyltryamine was used as an amine source during the amine-support treatment. Thus, the average membrane thickness of the MOF membrane was the same as in Example 1. The CO₂/N₂ permeance ratio was 40.

### Example 9

Processing conditions used in Example 9 were the same as those in Example 1, except that conditions for the Solvothermal synthesis of the MOF membrane were a temperature of 100° C. and a synthesis time of 10 hours, and conditions for the moisturization processing were a temperature of 30° C., a relative humidity of 80%, and a processing time of 12 hours. The average membrane thickness of the MOF membrane was 1.0 μm. The CO₂/N₂ permeance ratio was 55.

### Example 10

The MOF membrane was prepared in the same manner as in Example 1, and the amine-support treatment was conducted in the same manner as in Example 1. The moisturization processing was not performed. Thus, the average membrane thickness of the MOF membrane was the same as in Example 1. The CO₂/N₂ permeance ratio was 15.

### Example 11

### Support of Seed Crystals

A support with seed crystals supported thereon was obtained in the same manner as in Example 1, except that KMF-1 was used as the seed crystals.

### Generation of MOF Membrane

A starting material solution of KMF-1 was prepared by the same procedure as that for preparing the seed crystals. Then, the starting material solution and the support with the seed crystals supported thereon were placed in a Teflon (registered trademark) vessel, and Solvothermal synthesis was conducted at 100° C. for 20 hours. A resultant MOF membrane complex was cleaned with deionized water and ethanol three times. Thereafter, the MOF membrane complex was left to stand and dried in the atmosphere for 12 hours or more, and was then dried at 100° C. for 12 hours.

### Moisturization Processing

Moisturization processing was the same as in Example 1.

### Amine-Support Treatment

Amine-support treatment was the same as in Example 1.

### Result of Measuring Membrane Thickness

The average membrane thickness of the MOF membrane obtained in the same manner as in Example 1 was 1.2 μm.

Result of Measuring CO₂/N₂ Permeance Ratio

The CO₂/N₂ permeance ratio obtained in the same manner as in Example 1 was 25.

### Example 12

The amine-support treatment used in Example 12 was the same as that in Example 11, except that 2-(2-aminoethylamino) ethanol was used as an amine source. Thus, the average membrane thickness of the MOF membrane was the same as in Example 11. The CO₂/N₂ permeance ratio was 30.

### Example 13

### Support of Seed Crystals

A support with seed crystals supported thereon was obtained in the same manner as in Example 1, except that MIL-125-NH₂ (Ti) was used as the seed crystals, and water was used as a dispersion medium.

### Generation of MOF Membrane

A starting material solution of MIL-125-NH₂ (Ti) was prepared by the same procedure as that for preparing the seed crystals. Then, the starting material solution and the support with the seed crystals supported thereon were placed in a Teflon (registered trademark) vessel and subjected to Solvothermal synthesis conducted at 150° C. for 10 hours. A resultant MOF membrane complex was cleaned with deionized water and ethanol three times. Thereafter, the MOF membrane complex was left to stand and dried in the atmosphere for 12 hours or more, and was then dried at 100° C. for 12 hours.

### Moisturization Processing

Moisturization processing was the same as in Example 1.

### Amine-Support Treatment

Amine-support treatment was the same as in Example 1.

### Result of Measuring Membrane Thickness

The average membrane thickness of the MOF membrane obtained in the same manner as in Example 1 was 2.0 μm.

Result of Measuring CO₂/N₂ Permeance Ratio

The CO₂/N₂ permeance ratio obtained in the same manner as in Example 1 was 10.

### Example 14

### Support of Seed Crystals

A support with seed crystals supported thereon was obtained in the same manner as in Example 1, except that UiO-66-NH₂ (Zr) was used as the seed crystals, and water was used as a dispersion medium.

### Generation of MOF Membrane

A starting material solution of UiO-66-NH₂ (Zr) was prepared by the same procedure as that for preparing the seed crystals. Then, the starting material solution and the support with the seed crystals supported thereon were placed in a Teflon (registered trademark) vessel and subjected to Solvothermal synthesis conducted at 120° C. for 20 hours. A resultant MOF membrane complex was cleaned with deionized water and ethanol three times. Thereafter, the MOF membrane complex was left to stand and dried in the atmosphere for 12 hours or more, and was then dried at 100° C. for 12 hours.

### Moisturization Processing

Moisturization processing was the same as in Example 1.

### Amine-Support Treatment

Amine-support treatment was the same as in Example 1.

### Result of Measuring Membrane Thickness

The average membrane thickness of the MOF membrane obtained in the same manner as in Example 1 was 2.0 μm.

Result of Measuring CO₂/N₂ Permeance Ratio

The CO₂/N₂ permeance ratio obtained in the same manner as in Example 1 was 16.

### Example 15

### Support of Seed Crystals

A support with seed crystals supported thereon was obtained in the same manner as in Example 1, except that CAU-10-H was used as the seed crystals, and water was used as a dispersion medium.

### Generation of MOF Membrane

A starting material solution of CAU-10-H was prepared by the same procedure as that for preparing the seed crystals. Then, the starting material solution and the support with the seed crystals supported thereon were placed in a Teflon (registered trademark) vessel and subjected to Solvothermal synthesis conducted at 135° C. for 20 hours. A resultant MOF membrane complex was cleaned with deionized water and ethanol three times. Thereafter, the MOF membrane complex was left to stand and dried in the atmosphere for 12 hours or more, and was then dried at 100° C. for 12 hours.

### Moisturization Processing

Moisturization processing was the same as in Example 1.

### Amine-Support Treatment

Amine-support treatment was the same as in Example 1.

### Result of Measuring Membrane Thickness

The average membrane thickness of the MOF membrane obtained in the same manner as in Example 1 was 1.0 μm.

Result of Measuring CO₂/N₂ Permeance Ratio

The CO₂/N₂ permeance ratio obtained in the same manner as in Example 1 was 30.

### Example 16

The procedure used was the same as that in Example 1, except for the amine-support method. Thus, the average membrane thickness of the MOF membrane was the same as in Example 1.

### Amine-Support Treatment

Tetraethylenepentamine (TEPA) serving as an amine source was added to 200 mL of ethanol and agitated for 10 hours to prepare 0.1 mol/L of an amine-containing ethanol solution. The entire separation membrane with the MOF membrane deposited thereon was immersed in the amine-containing ethanol solution for 24 hours. Thereafter, the entire separation membrane was cleaned with only ethanol three times and dried at 100° C. for 12 hours so that the amine was supported on the MOF membrane. Through this treatment, a separation membrane complex was obtained.

Result of Measuring CO₂/N₂ Permeance Ratio

The CO₂/N₂ permeance ratio obtained in the same manner as in Example 1 was 10.

### Comparative Example 1

An MOF membrane was prepared in the same manner as in Example 1, and the moisturization processing and the amine-support treatment were both not performed. Thus, the average membrane thickness of the MOF membrane was the same as in Example 1. The CO₂/N₂ permeance ratio was 3.

### Comparative Example 2

Seed crystals of Mg-MOF-74 were obtained with reference to Document 3 described above (by NanyiWang and other four members). Specifically, magnesium nitrate hexahydrate (0.2375 g, 0.925 mmol) and 2,5-dihydroxy-terephthalic acid (0.1011 g, 0.509 mmol) were added to a mixed solvent of DMF, water, and ethanol mixed in a volume ratio of 15:1:1, so as to prepare a mixed solution. Then, the resultant solution was subjected to Solvothermal synthesis conducted at 120° C. for 24 hours. Precipitates were separated from the solution by a centrifugal separator and cleaned with deionized water and ethanol three times. Through the above process, MOF powder was obtained as the seed crystals of Mg-MOF-74.

### Support of Seed Crystals

A support with seed crystals supported thereon was obtained in the same manner as in Example 1, except that seed crystals of Mg-MOF-74 were used as the seed crystals, and water was used as a dispersion medium.

### Generation of MOF Membrane

A starting material solution of Mg-MOF-7 was prepared by the same procedure as that for preparing the seed crystals. Then, the starting material solution and the support with the seed crystals supported thereon were placed in a Teflon (registered trademark) vessel and subjected to Solvothermal synthesis conducted at 120° C. for 20 hours. A resultant MOF membrane complex was cleaned with deionized water and ethanol three times. Thereafter, the MOF membrane complex was left to stand and dried in the atmosphere for 12 hours or more and was then dried at 100° C. for 12 hours.

### Moisturization Processing

Moisturization processing was the same as in Example 1.

### Amine-Support Treatment

Amine-support treatment was the same as in Example 1.

### Result of Measuring Membrane Thickness

The average membrane thickness of the MOF membrane obtained in the same manner as in Example 1 was 5.0 μm.

Result of Measuring CO₂/N₂ Permeance Ratio

The CO₂/N₂ permeance ratio obtained in the same manner as in Example 1 was 0.5.

In the examples described above, the mean pore diameter of Al fumarate was 0.59 nm. The mean pore diameter of KMF-1 was 0.60 nm. The mean pore diameter of MIL-125-NH₂ (Ti) was 0.60 nm. The mean pore diameter of UiO-66-NH₂ (Zr) was 0.60 nm. The mean pore diameter of CAU-10-H was 0.40 nm. Meanwhile, the mean pore diameter of Mg-MOF-74 used in the comparative examples was 1.10 nm. It can be said from the above-described examples that high CO₂/N₂ permeance ratios can be achieved by causing an amine to be supported on an MOF membrane having a mean pore diameter of about 0.60 nm, i.e., greater than or equal to 0.40 nm and less than or equal to 0.70 nm. The type of a gas to be separated by the separation membrane complex 1 is not limited to CO₂, and the separation membrane complex 1 may also be used for the separation of other gases. It can be said from the above-described examples that an amine-supported MOF membrane suitable for the separation of a specific fluid can be obtained if the mean pore diameter is less than or equal to 0.90 nm, which is near the average value of 0.60 nm and 1.10 nm. Note that the mean pore diameter of the MOF membrane is practically greater than or equal to 0.40 nm.

Besides, if an amine is supported on the surface of the MOF membrane (i.e., the surface of the separation membrane 12) and in the pores thereof in the vicinity of that surface, it is possible to achieve the separation membrane 12 with high separation performance for a specific gas while suppressing deterioration in fluid permeability. In particular, this effect is thought to be effectively achieved as a result of the abundance of the amine per unit volume gradually decreasing from the surface of the separation membrane 12 toward the support 11.

It can be found from the above-described examples that the separation membrane complex 1 achieves a CO₂/N₂ permeance ratio of higher than or equal to 10. The CO₂/N₂ permeance ratio may become higher than or equal to 30 depending on the example.

The separation membrane complex 1 and the method of producing the separation membrane complex 1 described above may be modified in various ways.

In the production of the above-described separation membrane complex 1, the MOF type of the seed crystals and the MOF type of the MOF membrane do not necessarily have to be the same. The starting material solution may contain two or more types of ligands. The separation membrane complex 1 may be produced by a different method other than the above-escribed production method.

The separation apparatus 2 may separate a different substance other than those described above from a mixture of substances.

The configurations of the above-described preferred embodiment and variations may be appropriately combined as long as there are no mutual inconsistencies.

While the invention has been shown and described in detail, the foregoing description is in all aspects illustrative and not restrictive. It is therefore understood that numerous modifications and variations can be devised without departing from the scope of the invention.

### INDUSTRIAL APPLICABILITY

The separation membrane complex according to the present invention is applicable for the separation of various substances in various fields.

### REFERENCE SIGNS LIST

1 separation membrane complex
11 support
12 separation membrane
12a MOF membrane
S11 to S17 step

1. A separation membrane complex comprising:
a support that is porous; and
a separation membrane with an amine supported on a surface thereof and in pores thereof in the vicinity of said surface, the separation membrane being a membrane of a metal organic framework provided on said support and having a mean pore diameter of greater than or equal to 0.40 nm and less than or equal to 0.70 nm.

2. The separation membrane complex according to claim 1, wherein
metal ions serving as a component of said metal organic framework is at least one selected from a group consisting of Al³⁺, Co³⁺, Co²⁺, Ni²⁺, Ni⁺, Cu²⁺, Cu⁺, Zn²⁺, Fe³⁺, Fe²⁺, Ti³⁺, and Zr⁴⁺.

3. The separation membrane complex according to claim 1, wherein
an organic ligand serving as a component of said metal organic framework is a bidentate ligand that is an organic molecular ion having two carboxy groups.

4. The separation membrane complex according to claim 1, wherein
said amine includes one or more types of normal amines.

5. The separation membrane complex according to claim 1, wherein
a ratio of permeance of CO₂ to permeance of a target gas is higher than or equal to five, the target gas being a gas separated from said CO₂.

6. The separation membrane complex according to claim 1, wherein
said separation membrane has an average membrane thickness of greater than or equal to 0.5 μm and less than or equal to 2μ m.

7. The separation membrane complex according to claim 1, wherein
an abundance of said amine per unit volume gradually decreases from the surface of said separation membrane toward said support.

8. A method of producing a separation membrane complex, the method comprising:
a) depositing a seed crystal of a metal organic framework on a support that is porous;
b) preparing a starting material solution of a metal organic framework;
c) immersing said support in said starting material solution to form a membrane of said metal organic framework on said support by Solvothermal synthesis, said membrane of said metal organic framework having a mean pore diameter of greater than or equal to 0.40 nm and less than or equal to 0.90 nm; and
d) bringing an amine-containing solution into contact with a surface of said membrane of said metal organic framework.

9. The method of producing a separation membrane complex according to claim 8, the method further comprising, between said operations c) and d):
e) drying said membrane of said metal organic framework; and
f) keeping said membrane of said metal organic framework in a high-humidity environment.
